(19) United States
(12) Patent Application Publication
(10) Pub. No.: US 2014/0153225 A1
(43) Pub. Date: Jun. 5, 2014

(54) LED LIGHTING DEVICE

(71) Applicant: Icepipe Corporation, Seoul (KR)

(72) Inventor: Sang-Cheol Lee, Seoul (KR)

(73) Assignee: Icepipe Corporation, Seoul (KR)

(21) Appl. No.: 14/172,251

(22) Filed: Feb. 4, 2014

Related U.S. Application Data
(63) Continuation of application No. PCT/KR12/04274, filed on May 31, 2012.

(30) Foreign Application Priority Data
Aug. 8, 2011 (KR) 10-2011-0078775

(51) Int. Cl. F21V 29/00

(52) U.S. Cl. CPC F21V 29/20
USPC 362/157

(57) ABSTRACT

An LED lighting apparatus includes: a light source module having an LED light source therein; a thermal base coupled with the light source module and configured to receive heat generated by the light source module; a heat-dissipating member coupled with edge regions of the thermal base to discharge heat transferred from the thermal base and having a ventilation unit formed therein for opening a central area of the thermal base so as to facilitate air ventilation; and a power supply unit disposed outside the heat-dissipating member so as to be positioned in a path of air moving toward the heat-dissipating member and configured to supply electric power to the light source module, thereby improving the heat-dissipating efficiency by facilitating the air around the heat-dissipating member and the power supply unit to flow without stagnation and effectively preventing overheating of the power supply unit by cooling the power supply unit.

### CROSS REFERENCE TO RELATED APPLICATIONS

This application is a continuation of PCT/KR2012/004274 filed May 31, 2012, which claims the benefit of Korean Patent Application No. 10-2011-0078775, filed with the Korean Intellectual Property Office on Aug. 8, 2011, the disclosure of which is incorporated herein by reference in its entirety.

### BACKGROUND

1. Technical Field

The present invention relates to an LED lighting apparatus.

2. Background Art

An LED lighting apparatus has a large amount of heat generated due to heat generated by LED. Generally, when the LED lighting apparatus is overheated, the LED lighting apparatus may malfunction or be damaged, and thus it is essentially required to equip the LED lighting apparatus with a heat-dissipating structure in order to prevent the overheating. Moreover, a power supply apparatus for supplying electric power to LED also generates a large amount of heat and suffers with shortened life.

To prevent the overheating problem, Korean Patent Publication 2009-0095903 has disclosed a structure that discharges a linear heat radiation member on an external circumferential surface of the body surrounding a light source. However, in this kind of structure, the air having the heat held therein is stagnated on the exterior of the body in such a way that the problem of lowered heat-dissipating efficiency remains unsolved. Moreover, the heat generated from the light source is confined in the cylindrical body to cause a thermal bottleneck phenomenon, in which the heat confined in the cylindrical body is not transferred to the heat radiation member quickly enough.

Moreover, the power supply apparatus is simply exposed to an outside of the body to dissipate the heat, but this structure of dissipating the heat by simply being exposed has the air with the heat stagnated around, limiting the heat-dissipating capability.

### SUMMARY

The present invention provides an LED lighting apparatus that can increase heat-dissipating efficiencies of LED and a power supply unit by activating the flow of air around a heat-dissipating member.

An aspect of the present invention features an LED lighting apparatus that includes: a light source module having an LED light source therein; a thermal base coupled with the light source module and configured to receive heat generated by the light source module; a heat-dissipating member coupled with edge regions of the thermal base to discharge heat transferred from the thermal base and having a ventilation unit formed therein for opening a central area of the thermal base so as to facilitate air ventilation with an outside; and a power supply unit disposed outside the heat-dissipating member so as to be positioned in a path of air moving toward the heat-dissipating member and configured to supply electric power to the light source module.

The heat-dissipating member can include a spiral structure of heat-dissipating loop that repeatedly forms heat-absorbing units coupled to the edge regions of the thermal base to receive heat and heat-dissipating units separated from the heat-absorbing units to dissipate the absorbed heat.

The heat-dissipating loop can include an oscillating capillary tube type of heat-pipe loop, into which working fluid is injected.

The LED lighting apparatus can also include a case having the heat-dissipating member and the power supply unit accommodated therein and having an opening formed on an upper side thereof for allowing air to pass through.

The LED lighting apparatus can also include a front cover covering the light source module and having ventilation holes formed in edge regions thereof.

The LED lighting apparatus can also include a support member configured to separate the power supply unit from the thermal base and to support the power supply unit.

The LED light source can be provided in plurality, and the plurality of LED light sources can be disposed corresponding to the edge regions of the thermal base.

According to the present invention, the heat-dissipating efficiency can be improved by allowing the air around the heat-dissipating member and the power supply unit to flow easily without stagnation, and overheating of the power supply unit can be effectively prevented by additionally cooling the power supply unit by use of the air flow.

Moreover, since the heat generated from LED is spread out in wide direction, the heat-dissipating efficiency can be enhanced by preventing heat transfer from slowing down.

### BRIEF DESCRIPTION OF THE DRAWINGS

FIG. 1 is a perspective view of an LED lighting apparatus in accordance with an embodiment of the present invention.

FIG. 2 and FIG. 3 are exploded perspective views of the LED lighting apparatus in accordance with an embodiment of the present invention.

FIG. 4 is a perspective view of a heat-dissipating member of the LED lighting apparatus in accordance with an embodiment of the present invention.

FIG. 5 illustrates air flow in the LED lighting apparatus in accordance with an embodiment of the present invention.

### DETAILED DESCRIPTION

Hereinafter, a certain embodiment of the present invention will be described with reference to the accompanying drawings.

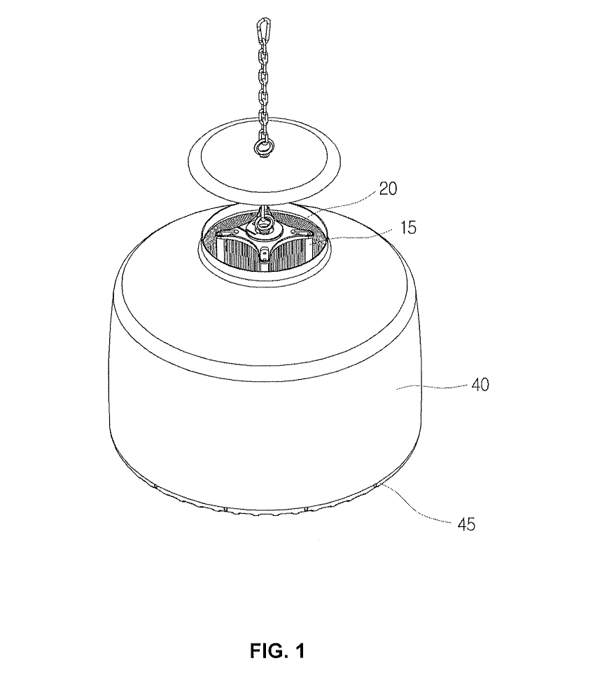

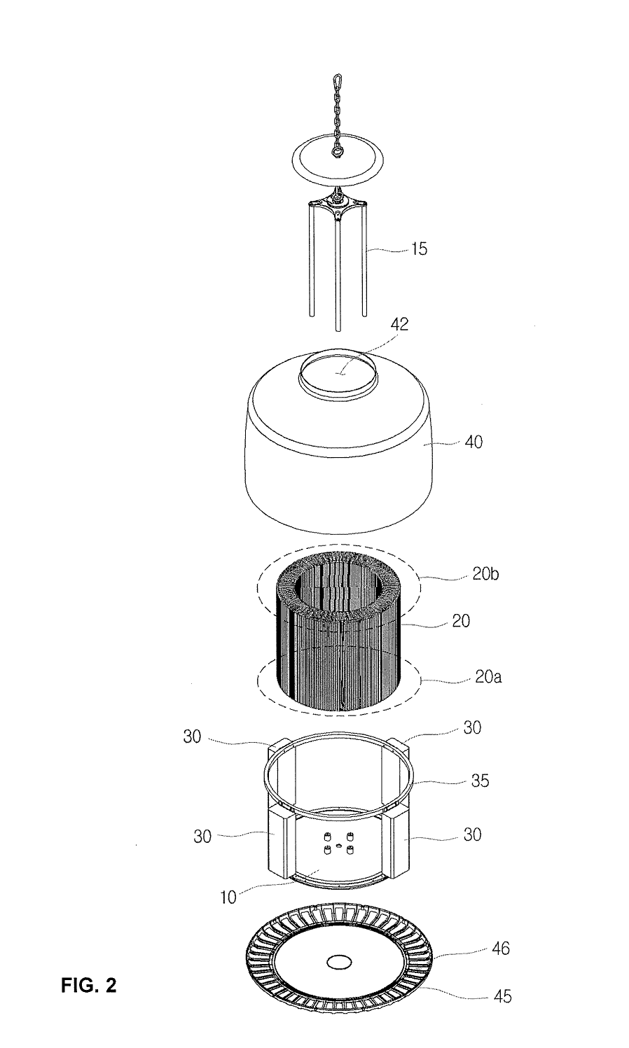

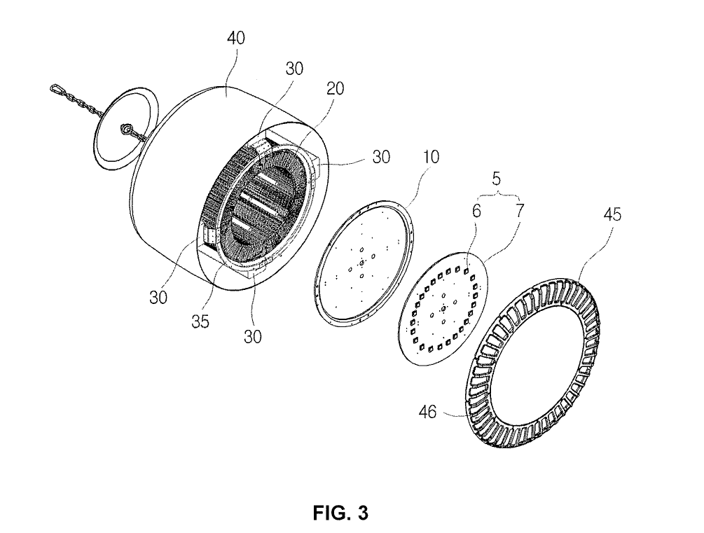

FIG. 1 is a perspective view of an LED lighting apparatus in accordance with an embodiment of the present invention, and FIG. 2 and FIG. 3 are exploded perspective views of the LED lighting apparatus in accordance with an embodiment of the present invention.

The LED lighting apparatus in accordance with an embodiment of the present invention includes a light source module 5, a thermal base 10, a heat-dissipating member 20 and a power supply unit 30.

The light source module 5 is a portion that includes an LED light source 6, which can emit light by use of electrical energy, to generate light required for lighting. As illustrated in FIG. 3, the light source module 5 in accordance with the present embodiment is constituted with the LED light source 6 and a module board 7, in which the LED light source 6 is mounted.

The thermal base 10 is a portion that receives heat generated by the LED light source 6 and transfers the heat to the heat-dissipating member 20. For this, one side of the thermal base 10 is coupled with the LED light source 6 so as to enable heat transfer, and an edge region of the thermal base 10 is coupled with the heat-dissipating member 20 so as to enable heat transfer. Moreover, the thermal base 10 is made of a material that transfers heat quickly. Accordingly, the heat absorbed by the thermal base 10 can be readily transferred to the heat-dissipating member 20.

Most of the heat absorbed by the thermal base 10 is dissipated through edge regions where the heat-dissipating member 20 is coupled. Accordingly, heat transfer passages, in which cross-sectional areas thereof are increased along the passages, are formed in the thermal base 10. Since the heat transfer becomes faster as the cross-sectional areas are increased, the heat absorbed by the thermal base 10 is not stagnated but can be quickly transferred to the heat-dissipating member 20 to increase the heat-dissipating efficiency. In the case where the LED light source 6 is provided in plurality, the plurality of LED light sources 6 can be arranged to correspond to the edge regions of the thermal base to shorten the heat transfer passages and further improve the speed of heat transfer to the heat-dissipating member 20.

As illustrated in FIG. 3, in the present embodiment, the light source module 5 having the plurality of circularly-arranged LED light sources 6 is mounted on one surface of the thermal base 10, which is made of a metallic material in the shape of a circular plate. The heat-dissipating member 20 in the shape of a circular cylinder is coupled to the edge region of the other surface of the thermal base 10.

The thermal base 10 in accordance with the present embodiment has a coupling device 15 coupled thereto for suspending the LED lighting apparatus from a ceiling and for supporting the LED lighting apparatus.

The heat-dissipating member 20 is a portion that is coupled with the edge region of the thermal base 10 to dissipate the heat transferred from the thermal base 10. Particularly, the heat-dissipating member 20 of the present embodiment is formed with a ventilation unit that opens a central area of the thermal base 10 and allows the air to flow freely so as to facilitate air ventilation to the outside.

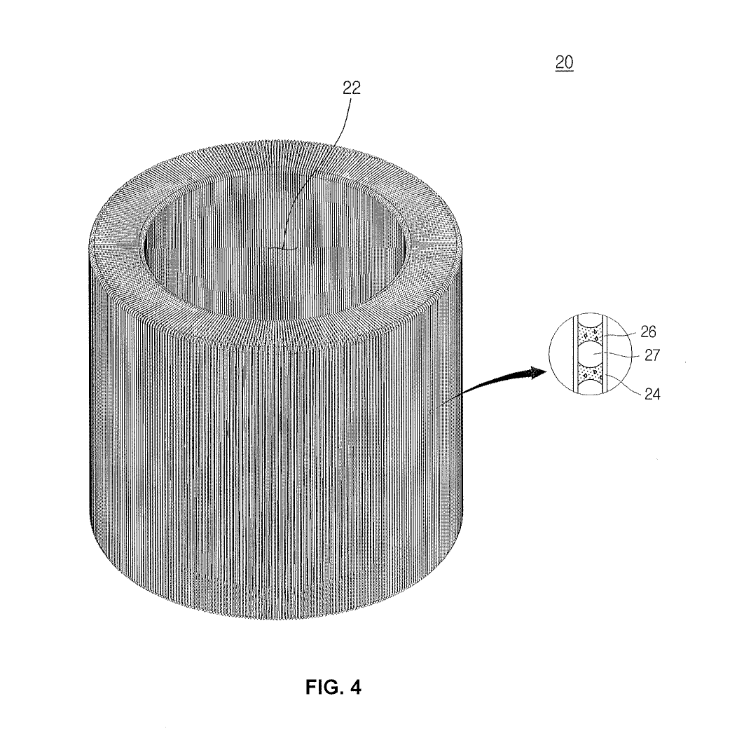

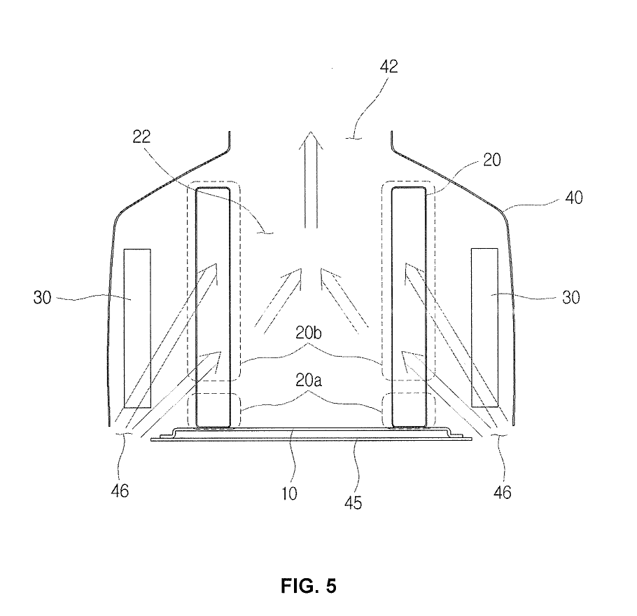

FIG. 4 is a perspective view of the heat-dissipating member of the LED lighting apparatus in accordance with an embodiment of the present invention, and FIG. 5 illustrates air flow in the LED lighting apparatus in accordance with an embodiment of the present invention.

As illustrated in FIGS. 4 and 5, the LED lighting apparatus of the present embodiment has an inside that is sufficiently hollow enough to open the central area of the thermal base 10, and a hollow space 22 inside the thermal base 10 allows for easy ventilation with the outside through the ventilation unit. Accordingly, the ventilation efficiency of the LED lighting apparatus is maximized so that the air around the heat-dissipating member 20 is not stagnated but flows freely to improve the heat-dissipating efficiency.

Specifically, the air in the hollow space 22 having passed through the heat-dissipating member 20 is in a heated state due to heat received from the heat-dissipating member 20 and thus naturally ascends and is discharged to an outside. When the air inside the hollow space 22 ascends, new, cold outside air is flowed in through the ventilation unit of the heat-dissipating member 20 in order to fill the hollow space 22. In other words, the cold, outside air is flowed in through the ventilation unit of the heat-dissipating member 20, and the flowed-in air is heated by the heat-dissipating member 20 and discharged, creating a continuous flow of air.

Therefore, by increasing the ventilation efficiency and facilitating continuous air flow around the heat-dissipating member 20, it becomes possible to prevent the air having the heat held therein from stagnating and lowering the heat-dissipating performance.

Meanwhile, the air ventilated inwardly can function to dissipate not only the heat of the heat-dissipating member 20 but also the heat absorbed in the thermal base 10, further improving the heat-dissipating efficiency. That is, a surface of the thermal base 10 can be also used as an effective area for heat dissipation.

Specifically, as illustrated in FIGS. 2 and 4, the heat-dissipating member 20 in accordance with the present embodiment can include a spiral structure of heat-dissipating loop that is constituted with linear members repeatedly forming a heat-absorbing unit 20a, which is coupled to the edge region of the thermal base 10 to receive heat, and a heat-dissipating unit 20b, which is separated from the heat-absorbing unit 20a and discharges the absorbed heat. In other words, the heat-dissipating loop has a spiral structure that reciprocates between a region that is coupled with the thermal base 10 and a region that is apart from the thermal base 10. Accordingly, a gap between spirals of the heat-dissipating loop becomes the ventilation unit, through which air is freely ventilated to the outside. In addition, by forming the heat-dissipating member 20 in a spiral structure, the surface area required for heat dissipation can be maximized in a limited space.

Moreover, the heat-dissipating loop can include an oscillating capillary tube type of heat-pipe loop, into which working fluid 26 is injected.

As illustrated in FIG. 4, the heat-pipe loop has an oscillating capillary tube type of heat pipe formed in a spiral structure therein, and the oscillating capillary tube type heat pipe has a structure in which the working fluid 26 and air bubbles 27 are injected in a predetermined ratio into a capillary tube 24 and then the capillary tube 24 is sealed from the outside. Accordingly, the oscillating capillary tube type heat pipe has a heat transfer cycle in which heat is mass-transported in the form of latent heat by volume expansion and condensation of the air bubbles 27 and the working fluid 26. As a result, the heat-dissipating performance of the heat-dissipating member 20 can be maximized.

The heat-dissipating member 20 constituted with the linear members is not restricted to the spiral loop type but can be embodied in various permutations, for example, a parallel-arranged plurality of linear members, each of which having a heat-absorbing unit coupled with the edge region of the thermal base 10 to receive heat and a heat-dissipating unit separated from the heat-absorbing unit to dissipate the absorbed heat.

The power supply unit 30 is a portion that supplies electric power required for the light source module 5. Particularly, the power supply unit 30 of the present embodiment is located on a movement path of the air toward the heat-dissipating member 20 so as to prevent overheating.

As shown in FIG. 5, the air is uninterruptedly flowed into the hollow space 22 by the heat-dissipating member 20 of the present embodiment. By having the power supply unit 30 of the present embodiment disposed outside the heat-dissipating member 20, into which the cold, outside air is flowed, the power supply unit 30 can be naturally cooled by being in contact with the outside air heading toward the heat-dissipating member 20. Accordingly, a continuous air flow is formed around the power supply unit 30, making it possible to prevent the air from stagnating and the power supply unit 30 from lowering the heat-dissipating efficiency.

Here, the power supply unit 30 can be separated from the thermal base 10 so as to facilitate the flow of the outside air around the power supply unit 30. As shown in FIGS. 2 and 3, the present embodiment can additionally have a support member 35 for separating the power supply unit 30 from the thermal base 10. Moreover, since the support member 35 prevents the power supply unit 30 and the thermal base 10 from directly contacting each other, thermal exchange between the power supply unit 30 and the light source module 5 through the thermal base 10 can be minimized.

The LED lighting apparatus in accordance with the present embodiment can additionally include a case 40 and a front cover 45 for protecting internal parts and facilitating an efficient air flow.

As illustrated in FIG. 2 and FIG. 5, the case 40 of the present embodiment is formed in the form of enveloping sides and an upper portion of the LED lighting apparatus so as to accommodate the heat-dissipating member 20 and the power supply unit 30 therein, thereby protecting the heat-dissipating member 20 and the power supply unit 30 from external impact and from contamination. Moreover, the case 40 has an opening 42 formed on an upper side thereof for having the air pass through, thereby allowing the air ascending in the hollow space 22 of the heat-dissipating member 20 to be discharged out of the case 40. Here, the opening 42 can be formed in a shape corresponding to the hollow space 22 of the heat-dissipating member 20 so that the air of the hollow space 22 can be guided to flow and discharged through the ascending air flow, without having to pass through the heat-dissipating member 20 again.

Moreover, as illustrated in FIG. 3 and FIG. 5, the front cover 45 of the present embodiment is disposed in front of the light source module 5 to protect the light source module 5 from outside. Here, the front cover 45 can be made of a light-transmitting material so as to allow the light of the LED light source to transmit. Moreover, the front cover 45 can have ventilation holes 46 formed in edge regions thereof for allowing the air to pass through, thereby allowing the air to flow into the case 40 from outside.

Specifically, as illustrated in FIG. 5, since a central area of the front cover 45 covers the light source module 5, the thermal base 10 coupled with the light source module 5 is positioned in the central area of the front cover 45. In this structure, by having the ventilation holes 46 formed in the edge regions of the front cover 45, the outside air passes around the thermal base 10 through the ventilation holes 46, flows along an internal wall of the case 40, and then moves toward the heat-dissipating member 20. In this process of air flow, the air is allowed to pass through the power supply unit 30 placed outside the heat-dissipating member 20.

Therefore, the outside air flowed through the ventilation holes 46 of the front cover 45 absorbs heat and becomes heated while sequentially passing through the thermal base 10, the power supply unit 30 and the heat-dissipating member 20, and the heated air is collected in the hollow space 22 of the heat-dissipating member 20 and then ascends to be discharged through the opening 42 on the upper side of the case 40.

Accordingly, the heat-dissipating efficiency can be improved by allowing the air around the heat-dissipating member 20 and the power supply unit 30 to flow easily without stagnation, and overheating of the power supply unit 30 can be effectively prevented by additionally cooling the power supply unit 30 by use of the air flow.

While the present invention has been described with reference to a certain embodiment, the embodiment is for illustrative purposes only and shall not limit the invention. It is to be appreciated that those skilled in the art can change or modify the embodiment without departing from the scope and spirit of the invention.

It shall be also appreciated that a very large number of embodiments other than that described herein are possible within the scope of the present invention, which shall be defined by the claims appended below.

What is claimed is:

1. An LED lighting apparatus comprising:
a light source module having an LED light source therein;
a thermal base coupled with the light source module and configured to receive heat generated by the light source module;
a heat-dissipating member coupled with edge regions of the thermal base to discharge heat transferred from the thermal base and having a ventilation unit formed therein for opening a central area of the thermal base so as to facilitate air ventilation with an outside; and
a power supply unit disposed outside the heat-dissipating member so as to be positioned in a path of air moving toward the heat-dissipating member and configured to supply electric power to the light source module.

2. The LED light apparatus of claim 1, wherein the heat-dissipating member comprises a spiral structure of heat-dissipating loop that repeatedly forms heat-absorbing units coupled to the edge regions of the thermal base to receive heat and heat-dissipating units separated from the heat-absorbing units to dissipate the absorbed heat.

3. The LED lighting apparatus of claim 2, wherein the heat-dissipating loop comprises an oscillating capillary tube type of heat-pipe loop, into which working fluid is injected.

4. The LED lighting apparatus of claim 1, further comprising a case having the heat-dissipating member and the power supply unit accommodated therein and having an opening formed on an upper side thereof for allowing air to pass through.

5. The LED lighting apparatus of claim 1, further comprising a front cover covering the light source module and having ventilation holes formed in edge regions thereof.

6. The LED lighting apparatus of claim 1, further comprising a support member configured to separate the power supply unit from the thermal base and to support the power supply unit.

7. The LED lighting apparatus of claim 1, wherein the LED light source is provided in plurality, and
wherein the plurality of LED light sources are disposed corresponding to the edge regions of the thermal base.
